(19) United States
(12) Patent Application Publication
(10) Pub. No.: US 2010/0043591 A1
(43) Pub. Date: Feb. 25, 2010

(54) CRANK HANDLE APPARATUS FOR DRAW-OUT CIRCUIT BREAKER

(76) Inventors: Jian Sheng Bi, Shanghai (CN); Rong Zhang Liu, Shanghai (CN)

Correspondence Address: HARNESS, DICKEY & PIERCE, P.L.C., P.O.BOX 8910, RESTON, VA, 20195, US

(21) Appl. No.: 12/450,279

(22) PCT Filed: Mar. 20, 2008
(86) PCT No.: PCT/CN2008/000553

§ 371 Date: Sep. 18, 2009

(30) Foreign Application Priority Data
Mar. 20, 2007 (CN) 200710088706.8

(51) Int. Cl. G05G 1/00

(52) U.S. Cl. 74/545

(57) ABSTRACT

A crank handle apparatus for a draw-out circuit breaker is disclosed. In at least one embodiment, the crank handle apparatus includes a crank, a locating piece, a button, a locking plate provided with a projecting part, and a retractable connecting link. A taken-in locking slot and a draw-out locking slot are provided in both ends of the crank. The locating piece includes a drawing gear which is wedged into the taken-in locking slot and the drawn-out locking slot respectively, and a locating slope which is connected with a locating spring apparatus. A button slope is provided in the button. A first resetting spring apparatus is provided in the button slope. A slope part of the button slope and a slope part of the locating slope are opposite and are in contact with each other. The projecting part is suppressed against or departed from the locating piece when the locking plate is moved.

### PRIORITY STATEMENT

This application is the national phase under 35 U.S.C. §371 of PCT International Application No. PCT/CN2008/000553 which has an International filing date of Mar. 20, 2008, which designated the United States of America, and which claims priority on Chinese patent application number 200710088706.8 filed Mar. 20, 2007, the entire contents of each of which are hereby incorporated herein by reference.

### FIELD

At least one embodiment of the present invention generally relates to a crank handle apparatus for a draw-out circuit breaker and, particularly, to a concealed retractable crank handle apparatus.

### BACKGROUND

A draw-out circuit breaker is a common circuit breaker, in which a breaker body which can be drawn out or pushed in is disposed on a solid drawer base, and the panel of the breaker body is provided thereon with a containing box for placing the breaker's crank handle.

A crank handle apparatus for a circuit breaker is disclosed in Chinese patent no. CN02808698. As shown in FIG. 1, it comprises a crank 51, one end of which is connected to a driving shaft, and by rotating the crank 51, the driving shaft is made to rotate so as to carry a turbine to rotate, thus realizing the drawing-out or pushing-in of the breaker body (not shown in the figure). The other end of the crank 51 is connected to one end of a connecting rod 52, and the connecting rod 52 is connected at the other end thereof to a handle 53. The crank handle apparatus is further provided with a latching rod 54 to avoid the drawing-out of the crank 51 at an inappropriate time. The crank 51 is provided with a latching slot 511, and a projecting tab 541 on the latching rod 54 is locked in the latching slot 511 when the crank 51 is at a taken-in position.

When there is a need for drawing out the breaker body, the latching rod 54 is first lifted along the direction shown by the arrow A to withdraw the projecting tab 541 from the latching slot 511, and then the connecting rod 52 is pulled outwards along the direction shown by the arrow B so as to pull the crank 51 and the handle 53 out together from the panel's taken-in box. After the handle 53 has been drawn out along the direction shown by the arrow C, the operator can hold the handle to rotate the crank so as to carry the driving shaft to rotate and draw out the breaker body.

However, since the latching rod is exposed outside the panel, it is still possible for the crank to leave its locking position due to careless operation; furthermore, due to the breaker panel's limited space, the connecting rod in the crank handle apparatus is usually quite short, so that it is quite difficult for an operator to rotate the crank.

### SUMMARY

At least one embodiment of the present invention provides a crank handle apparatus for a draw-out circuit breaker which has a double-locking mechanism, thus improving the locking reliability. Since only the control end of the locking mechanism is kept out of the panel and the remaining parts are generally arranged within the panel, the maloperation of the crank handle can be avoided. Furthermore, the force arm for rotating the crank can be lengthened without increasing the panel space to ensure a reliable, convenient and labor-saving operation for drawing-out or pushing-in the breaker body.

At least one embodiment of the present invention provides a crank handle apparatus for a draw-out circuit breaker, which comprises a crank and a locating piece for locating the crank, wherein the crank is provided with a taken-in locking slot at one axial end thereof and a drawn-out locking slot at the other end thereof; the locating piece comprises a locking gear, wherein when the crank is moved axially the locking gear is locked into the taken-in locking slot or the drawn-out locking slot, so as to locate the crank, the locating piece is provided thereon with a locating slope, and the locating slope is coupled with locating spring device; the crank handle apparatus further comprises a button, which is provided thereon with a button slope, and the button slope is coupled with first resetting spring device for resetting the button, and the locating slope and the button slope are opposite to each other and in contact with the button slope under the effect of the locating spring device.

At least one embodiment of the present invention further provides a crank handle apparatus for a draw-out circuit breaker, which comprises a crank and a locating piece for locating the crank, wherein the crank is provided with a taken-in locking slot at one axial end thereof and a drawn-out locking slot at the other end thereof; the locating piece comprises a locking gear, wherein when the crank is moved axially the locking gear is locked into the taken-in locking slot or the drawn-out locking slot, so as to locate the crank; and the crank handle apparatus further comprises a locking plate, wherein the locking plate is configured to be movable along the axial direction of the crank, the locating piece is located between the locking plate and the crank, the locking plate is provided thereon with a projecting tab oriented towards the locating piece, and the projecting tab abuts against or separates from the locating piece when the locking plate is moved.

According to another aspect of at least one embodiment of the present invention, the crank handle apparatus for a drawn-out circuit breaker further comprises a connecting rod, wherein the connecting rod comprises a rod body and a rod sleeve, the rod sleeve is movable longitudinally along the rod body with the rod body sleeved therein, wherein the rod body is provided thereon with a locating plate, the rod sleeve is provided thereon with a locating hole, so that when the rod sleeve is moved longitudinally along the rod body, the locating plate is locked into the locating hole.

### BRIEF DESCRIPTION OF THE DRAWINGS

FIG. 1 is a schematic structural diagram of a currently available crank handle apparatus for a drawn-out circuit breaker;

FIG. 2 is a schematic structural diagram of an embodiment of a crank handle apparatus for a drawn-out circuit breaker according to the present invention, wherein the crank handle apparatus is at a taken-in state;

FIG. 3 is another schematic structural diagram of the embodiment of the crank handle apparatus for a drawn-out circuit breaker according to the present invention, wherein the crank handle apparatus is at a drawn-out state.

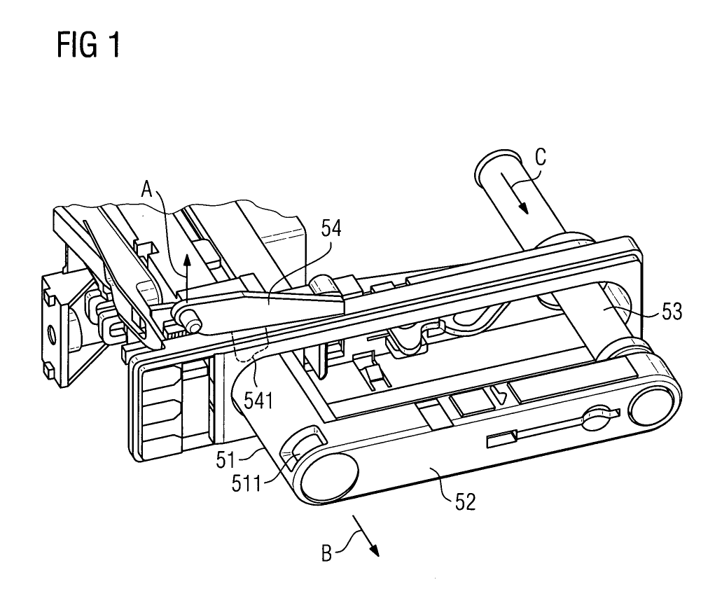

### DETAILED DESCRIPTION OF THE EXAMPLE EMBODIMENTS

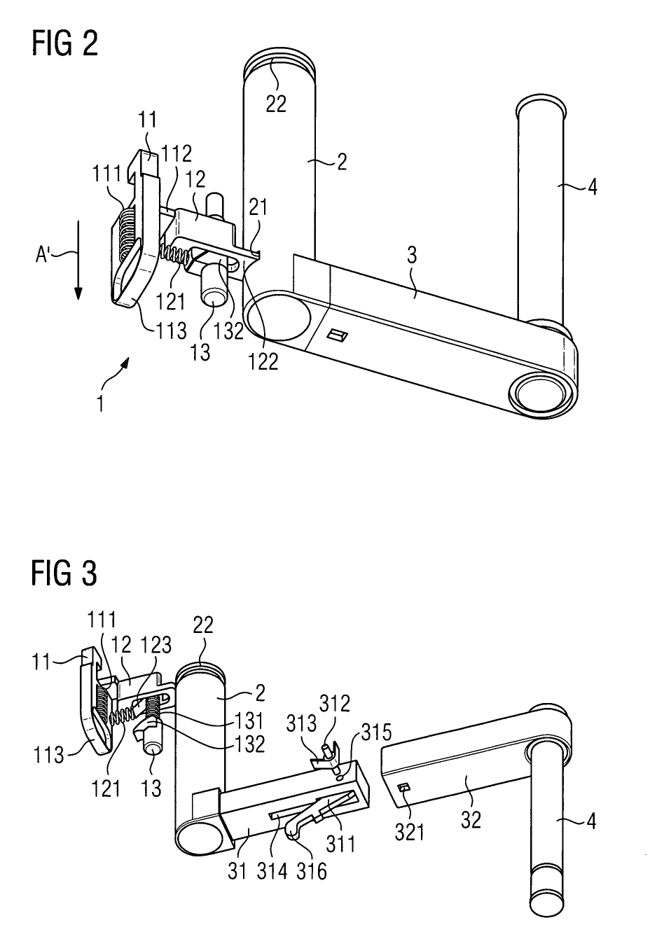

The present invention will be described in detail hereinbelow in combination with the embodiments illustrated in the accompanying drawings. As shown in FIG. 2, the crank handle apparatus for a drawn-out circuit breaker of an embodiment of the present invention comprises a locking mechanism 1, a crank 2, a connecting rod 3 and a handle 4.

The structure and operation principles of the locking mechanism 1 will be described first. The locking mechanism 1 realizes the function of double-locking with a locking plate 11 and a locating piece 12.

As shown in FIG. 2, one end of the crank 2 is provided with a taken-in locking slot 21, and the other end is provided with an annular drawn-out locking slot 22 along the circumferential direction. The locating piece 12 has a locking gear 122, and the locking gear 122 is locked into the taken-in locking slot 21 on the crank 2 when the crank handle apparatus is at the taken-in position and locked into the drawn-out locking slot 22 when the crank handle apparatus is at the drawn-out position. The locating piece 12 is further provided with a locating slope 123 (see FIG. 3), wherein the locating slope 123 is coupled with locating spring device 121, and the other end of the locating spring device 121 can be fixed on the breaker in a manner known to those skilled in the art.

As shown in FIG. 3, a locating piece button 13 is provided with a button slope 132 matching the locating slope 123 in shape, and the end of the button slope 132 is coupled with the first resetting spring device 131. The other end of the first resetting spring device 131 can be fixed on the breaker in a manner known to those skilled in the art. The slope part of the button slope 132 and the slope part of the locating slope 123 are configured to be opposite to and in contact with each other. When the locking gear 122 is locked into the taken-in locking slot 21 on the crank 2, by pressing the button 13 the button slope 132 is made to push the locating slope 123 along the direction perpendicular to that in which the button is pressed, so as to press the first resetting spring device 131 and the locating spring device 121 and to further carry the locating piece 12 to move towards the direction for withdrawing from the taken-in locking slot 21. When the locking gear 122 of the locating piece 12 is separated from the taken-in locking slot 21, by pulling the crank 2 along the direction A′ (see FIG. 2) and at the same time releasing the button 13, the button 13 is reset under the effect of spring force of the first resetting spring device 131. As the crank 2 is moved outwards along the direction A′, the locking gear 122 is automatically locked into the drawn-out locking slot 22 to lock the crank 2 under the effect of spring force of the locating spring device 121 when the locking gear 122 on the locating piece 12 is in contact with the drawn-out locking slot 22 on the crank 2.

Similarly, when the crank 2 needs to be taken in, that is, when the locking gear 122 is to be moved from the drawn-out locking slot 22 into the taken-in locking slot 21, the button 13 is pressed to make the button slope 132 push the locating slope 123 along the direction perpendicular to that in which the button is pressed, so as to press the first resetting spring device 131 and the locating spring device 121 and to further carry the locating piece 12 to move towards the direction for withdrawing from the drawn-out locking slot 22. When the locking gear 122 of the locating piece 12 is separated from the drawn-out locking slot 22, by pushing the crank 2 along the direction opposite to the direction A′ and at the same time releasing the button 13, the button 13 is reset under the effect of spring force of the first resetting spring device 131. As the crank 2 is moved inwards along the direction opposite to the direction A′, the locking gear 122 is automatically locked into the taken-in locking slot 21 to lock the crank 2 under the effect of spring force of the locating spring device 121 when the locking gear 122 on the locating piece 12 is in contact with the taken-in locking slot 21 on the crank 2.

Next, the secondary locking function of the locking plate 11 will be described. The locking plate 11 is configured to locate the locating piece 12 between the locking plate 11 and the crank 2, and the locking plate 11 comprises second resetting spring device 111, a projecting tab 112 and a handle portion 113. One end of the second resetting spring device 111 is coupled with the locking plate 11, and the other end is fixed on the breaker in a manner known to those skilled in the art. When the locking gear 122 of the locating piece 12 is locked into the taken-in locking slot 21 of the crank 2, the handle portion 113 of the locking plate 11 is pulled along the direction A′ to abut the projecting tab 112 against the locating piece 12, and at the same time the second resetting spring device 111 is stretched.

Since the locking plate 11 is fixed in the radial direction of the crank 2 and its projecting tab 112 abuts against the locating piece 12 so as to constrain the movement of the locating piece 12 in the radial direction of the crank 2, the locating piece 12 is fixedly locked in the taken-in locking slot 21 of the crank 2 and is unmovable under the effect of the projecting tab 112, so as to have the effect in locking the locating piece 12. In practical applications, the handle portion 113 of the locking plate 11 is arranged outside a breaker housing to facilitate users in pulling the locking plate 11 by the handle portion 113, while the second resetting spring device 111 and the projecting tab 112 are arranged within the breaker housing. After the locking plate 11 has been drawn out, a pin or other parts (not shown in the figure) can be used to pass through the handle portion 113 and fix the locking plate 11 on the housing.

Similarly, when the locking gear 122 of the locating piece 12 is locked into the drawn-out locking slot 22 of the crank 2, and above operations can also be used to lock the locating piece 12.

When the locking of the locating piece 12 by the locking plate 11 needs to be released, only the fixation of the handle portion 113 of the locking plate 11 on the housing needs to be released, and then the locking plate 11 is reset along the direction opposite to the direction A′ due to the spring force of the second resetting spring device 111 to move the projecting tab 112 away from the locating piece 12 so as to release the locking of the locating piece 12. When the locating piece 12 is locked by the locking plate 11, the button 13 cannot be pressed down at this time because the locking plate 11 is fixed along the radial direction of the crank 2 and its projecting tab 112 abuts against the locating piece 12 to constrain the movement of the locating piece 12 along the radial direction of the crank 2, thus the maloperation on the crank 2 at a taken-in or drawn-out state is effectively avoided.

After the locking of the locating piece 12 by the locking plate 11 has been released, the locating piece 12 can move a distance h along the radial direction of the crank 2 since at this time the projecting tab 112 is separated from the locating piece 12, by pressing down the button 13 at this moment the locating piece 12 is enabled to move along the direction of the locking plate 11 so as to withdraw the locking gear 122 from the taken-in locking slot 21 or the drawn-out locking slot 22 of the crank 2 and further to draw out the crank 2 from or push the crank into the breaker housing.

In an embodiment of the present invention, it only needs to press the button 13 once in order to realize the whole process for the crank 2 to change from taken-in to drawn-out or from drawn-out to taken-in, which simplifies the retraction operation of the crank 2. At the same time, the operation mode by a button greatly improves the operating reliability compared with the prior operation modes of pushing-pulling and ejecting-withdrawing. In the practical applications, since generally only the handle portion 113 and the button 13 need to be arranged outside the breaker housing and the remaining parts of the locking mechanism are within the breaker housing, such a conceal design further greatly reduces the possibility of maloperation.

The structure and operation principles of the connecting rod 3 will be described below. In an embodiment of the present invention, the connecting rod 3 is designed to be retractable so as to lengthen the force arm for rotating the crank to ensure a reliable, convenient and labor-saving operation for drawing-out or pushing-in the breaker body.

The end of the crank 2 close to the taken-in locking slot 21 is connected to a connecting rod 3, and the other end of the connecting rod 3 is provided with a handle 4. The handle 4 can be pulled out or retracted along a direction approximately parallel to the crank 2 according to needs.

As shown in FIG. 3, the connecting rod 3 comprises a rod body 31 and a rod sleeve 32, and the rod sleeve 32 can accommodate the rod body 31 and move longitudinally along the rod body 31 so as to make the connecting rod 3 retractable.

In the present embodiment, the rod body 31 comprises a locating plate 311, a pin 312 and torsional spring device 313. The rod body 31 is provided with a slot 314 and a hole 315 along the longitudinal direction of the rod body 31, and the locating plate 311 is accommodated in the slot 314. The locating plate 311 is provided with a hole (not shown in the figure) corresponding to the hole 315. The pin 312 passes through the hole 315 of the rod body 31 and the hole on the locating plate 311, fixes one end of the locating plate 311 in the rod body 31 and enables the locating plate 311 to rotate around the pin 312. The pin 312 is further provided with the torsional spring device 313. The other end of the locating plate 311 is a free end and has a projecting portion 316. The rod sleeve 32 is provided with a locating hole 321, with the locating hole 321 matching in shape with the projecting portion 316 at the free end of the locating plate 311, and the projecting portion 316 at the free end can lock and fix the rod sleeve 32 when it is passed through the locating hole 321.

In order to rotate the crank 2 with less effort, the rod sleeve 32 can be pulled out along the longitudinal direction of the rod body 31. When pulling out the rod sleeve 32, the torsional spring device 313 rotates to carry the locating plate 311 to rotate around the pin 312 and to lift off the rod body 31. As the rod sleeve 32 moves, the projecting portion 316 on the locating plate 311 will be locked into the locating hole 321 when the locating hole 321 on the rod sleeve moves just above the free end of the locating plate 311, and then the rod sleeve 32 cannot be pulled any more thus fixing the lengthened connecting rod 3. When there is a need to retract the rod sleeve 32, the projecting portion 316 of the locating plate 311 on the rod body 31 is pressed to separate the projecting portion from the locating hole 321 on the rod sleeve 32, so as to push back the rod sleeve 32 and reset the connecting rod 3 to its initial length.

Operation procedures of the crank handle apparatus for a circuit breaker of the present invention are as follows: when the circuit breaker body needs to be drawn out from or pushed into a drawer base,
resetting the locking plate 11;
pressing down the button 13 to push the locking gear 122 of the locating piece 12 out of the taken-in locking slot 21;
then drawing the crank 2 outwards and releasing the button 13 until the locking gear 122 is locked into the drawn-out locking slot 22;
drawing out the handle 4, and then drawing out the rod sleeve 32 along the longitudinal direction of the connecting rod 3 until the locating plate 311 is locked into the locating hole 321;
swinging the handle 4 to carry the crank 2 to rotate, and in turn to carry the transmission mechanism to move;
after the circuit breaker has reached the required position, pushing the handle 4 inwards, pressing down the locating plate 311 to separate it from the locating hole 321, and then retracting the rod sleeve 32 along the longitudinal direction of the connecting rod 3 until it returns to the initial position;
pressing down the button 13 again to withdraw the locking gear 122 of the locating piece 12 from the drawn-out locking slot 22;
pushing in the crank 2 and releasing the button 13 until the locking gear 122 is locked into the taken-in locking slot 21; and
finally pulling the locking plate 11 to lock the locating piece 12.

It is obvious that those skilled in the art can understand that the connecting rod retraction mode and the locking mode in the present invention are only examples, and the retraction of the connecting rod and the locking of the locking mechanism can be realized with other similar structures. In at least one embodiment of the present invention, the first spring device, the second spring device, the locating spring device and the torsional spring device are all springs, while it is obvious that other elastic devices well known to those skilled in the art can also be used.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A crank handle apparatus for a draw-out circuit breaker, comprising:
a crank, including a taken-in locking slot at one axial end of the crank and a drawn-out locking slot at the other end of the crank;
a locating piece for locating the crank, said locating piece comprising a locking gear, wherein when said crank is moved axially, the locking gear is locked into the taken-in locking slot or the drawn-out locking slot so as to locate said crank, said locating piece further comprising a locating slope, said locating slope being coupled with at least one locating spring device; and
a button including a button slope, said button slope being coupled with at least one first resetting spring device for resetting said button, and said locating slope and said button slope being opposite each other and said locating slope being in contact with said button slope under the effect of said at least one locating spring device.

2. The crank handle apparatus as claimed in claim 1, wherein at least one of said at least one first resetting spring device and said at least one locating spring device is a spring.

3. The crank handle apparatus as claimed in claim 1, further comprising a connecting rod, one end of said connecting rod being coupled with the end of said crank relatively closest to said taken-in locking slot.

4. The crank handle apparatus as claimed in claim 3, further comprising a handle, the handle passes through the other end of said connecting rod and adapted to carry the crank to rotate by way of the connecting rod.

5. The crank handle apparatus as claimed in claim 3, wherein said connecting rod comprises a rod body and a rod sleeve, said rod sleeve being movable longitudinally along said rod body with said rod body sleeved therein, wherein said rod body includes a locating plate, said rod sleeve including a locating hole, so that when said rod sleeve is moved longitudinally along said rod body, said locating plate is locked into said locating hole.

6. The crank handle apparatus as claimed in claim 5, wherein said rod body includes a slot and a hole, the locating plate being accommodated in the slot, a pin being inserted with one end thereof into the hole and fixed onto one end of the locating plate, and the other end of the pin being exposed out of the hole and fixedly mounting torsional spring device.

7. The crank handle apparatus as claimed in claim 6, wherein the other end of said locating plate has a projecting portion, and when said rod sleeve is moved longitudinally along said rod body, the projecting portion of said locating plate is locked into said locating hole under the effect of said torsional spring device.

8. The crank handle apparatus as claimed in claim 6, wherein said torsional spring device are a spring.

9. A crank handle apparatus for a draw-out circuit breaker, comprising:
a crank including a taken-in locking slot at one axial end of the crank and a drawn-out locking slot at the other end of the crank;
a locating piece for locating the crank, said locating piece including a locking gear, wherein when said crank is moved axially, the locking gear is locked into at least one of the taken-in locking slot and the drawn-out locking slot, so as to locate said crank; and
a locking plate, configured to be movable along the axial direction of said crank and configured to be fixed in the radial direction of the crank, said locating piece being located between said locking plate and said crank, said locking plate including a projecting tab oriented towards said locating piece, said projecting tab abutting against or separating from said locating piece when said locking plate is moved.

10. The crank handle apparatus as claimed in claim 9, wherein said locking plate is coupled with at least one second resetting spring device, and wherein said second resetting spring device is pressed or pulled when the locking plate is moved.

11. The crank handle apparatus as claimed in claim 9, wherein said locating piece further includes a locating slope, the locating slope being coupled with at least one locating spring device and a button, and wherein the button includes a button slope, the button slope including at least one first resetting spring device, the slope part of the button slope and the slope part of said locating slope being opposite to and in contact with each other.

12. The crank handle apparatus as claimed in claim 11, wherein at least one of said first resetting spring device and said locating spring device is a spring.

13. The crank handle apparatus as claimed in claim 9, further comprising a connecting rod, with one end of said connecting rod being coupled with the end of said crank relatively closest to said taken-in locking slot.

14. The crank handle apparatus as claimed in claim 9, further comprising a handle, wherein the handle passes through the other end of said connecting rod and is adapted to bring the crank to rotate by way of the connecting rod.

15. The crank handle apparatus as claimed in claim 13, wherein said connecting rod comprises a rod body and a rod sleeve, said rod sleeve being movable longitudinally along said rod body with said rod body sleeved therein, and wherein said rod body includes a locating plate and a locating hole, and when said rod sleeve is moved longitudinally along said rod body, said locating plate is locked into said locating hole.

16. The crank handle apparatus as claimed in claim 15, wherein said rod body is provided with a slot and a hole, and wherein the locating plate is accommodated in the slot, a pin being inserted with one end thereof into the hole and fixed onto one end of the locating plate, and the other end of the pin being provided with torsional spring device.

17. The crank handle apparatus as claimed in claim 15, wherein the other end of said locating plate includes a projecting portion, and wherein said projecting portion of the locating plate is locked into said locating hole under the effect of said torsional spring device when said rod sleeve is moved longitudinally along said rod body.

18. The crank handle apparatus as claimed in claim 16, wherein said torsional spring device is a spring.

19. The crank handle apparatus as claimed in claim 7, wherein said torsional spring device are a spring.

20. The crank handle apparatus as claimed in claim 11, wherein said locking plate is coupled with at least one second resetting spring device, and wherein said second resetting spring device is pressed or pulled when the locking plate is moved.

21. The crank handle apparatus as claimed in claim 20, wherein at least one of said first resetting spring device, said second resetting spring device and said locating spring device is a spring.

22. The crank handle apparatus as claimed in claim 17, wherein said torsional spring device is a spring.
